(19) United States
(12) Patent Application Publication
(10) Pub. No.: US 2009/0028636 A1
(43) Pub. Date: Jan. 29, 2009

(54) ROTARY COUPLING

(76) Inventor: Gerhard KIRSCHEY, Wuppertal (DE)

Correspondence Address: K.F. ROSS P.C., 5683 RIVERDALE AVENUE, SUITE 203 BOX 900, BRONX, NY, 10471-0900, US

(21) Appl. No.: 12/179,729

(22) Filed: Jul. 25, 2008

(30) Foreign Application Priority Data
Jul. 25, 2007 (EP) 07014586.7

(51) Int. Cl. F16D 1/06

(52) U.S. Cl. 403/345

(57) ABSTRACT

A rotary coupling has an inner part centered on and rotatable about a main axis and having a radially outwardly directed outer surface and an outer part coaxial with the inner part and having a radially inwardly directed inner surface bearing on the inner-part outer surface. The two parts are formed at the surfaces with an annular array of axially extending holes each having an outer half in the outer part and an inner half in the inner part. Respective pins set in the bores angularly couple the inner part to the outer part. Screwthread formations engaged between the inner and outer parts lock same against relative axial movement.

### FIELD OF THE INVENTION

The present invention relates to a coupling. More particularly this invention concerns a coupling for transmitting torque between two coaxial bodies.

### BACKGROUND OF THE INVENTION

A coupling used to rotationally interconnect two bodies that rotate around a common rotational axis has a first or inner part and a second or outer part connected or connectable thereto via coupling surfaces, with force-transmitting pins being provided for transmitting torque that are pressed into bores running parallel to the rotational axis and formed in the bodies, each approximately half in each body, and a screw connection acting in the direction of the rotational axis securing the two parts in an axially fixed manner. In particular, the invention relates to a flange hub for couplings for the rotational connection of machine parts.

In order to transfer rotational momentum in a connection between two bodies that are rotatable around a common rotational axis under normal operating conditions, it is important for the connecting means be very tight, not acting in shear. For this reason, a solution that has proven itself is force-transmitting pins that are pressed into bores running in a direction parallel to the rotational axis and that bisected by an imaginary cylindrical surface formed by the engaging inner and outer surfaces.

In drive engineering, flange hubs of considerable dimensions are used, for example, in elastic couplings for ship drives. Up to now, they have been produced primarily by machining a cast steel rod. This requires particularly large and high-performance mechanical facilities and relatively large amounts of material and moreover causes a considerable amount of waste from cutting the workpiece. The lack of flexibility in availability is particularly serious because it is hardly possible to keep blanks in stock for all sizes that come into consideration.

One example of a connection of this type, upon which the present invention is based, is shown and described in FR 274,958. Here, the first inner part is a shaft and the second outer part is a flywheel that is coupled for rotational synchronization by means of the force-transmitting pins mentioned above. Here, the force-transmitting pins also couple a pressure sleeve located in the vicinity of the flywheel with the shaft as well. The shaft end has threaded pins such that the flywheel and shaft may be fixed to one another in the axial direction by means of nuts screwed thereon.

Connections like the type described above may be used everywhere where it is important for at least two machine elements that rotate or are driven around a common rotational axis to be coupled to one another for excellent transfer of rotational momentum.

### OBJECTS OF THE INVENTION

It is therefore an object of the present invention to provide an improved rotary coupling.

Another object is the provision of such an improved rotary coupling that overcomes the above-given disadvantages, in particular that, unlike the coupling described in FR 274 958, makes it possible for a hollow shaft to be coupled directly to the flywheel and be axially secured at the same time.

Another object of the present invention is to provide ways in which this may be achieved in a simple manner.

A further object of the invention is to use a rotationally secure connection with the aid of force-transmitting pins of the known type to produce a flange hub with a hollow cylindrical hub and an annular disk to be connected thereto as the flange in an economical fashion.

### SUMMARY OF THE INVENTION

A rotary coupling has according to the invention an inner part centered on and rotatable about a main axis and having a radially outwardly directed outer surface and an outer part coaxial with the inner part and having a radially inwardly directed inner surface bearing on the inner-part outer surface. The two parts are formed at the surfaces with an annular array of axially extending holes each having an outer half in the outer part and an inner half in the inner part. Respective pins set in the bores angularly couple the inner part to the outer part. Screwthread formations engaged between the inner and outer parts lock same against relative axial movement.

Using a connection upon which the invention is based, the hub and flange may each be produced separately in a simpler and less expensive manner and may be connected to one another in a fixed fashion using the known connection techniques. The hub body may be turned or spun from rod or pipe material and the flange may be produced as an annular disk. This process negates all of the disadvantages listed above.

A first connection that takes into account the aspects of the invention is characterized in that the coupling surfaces are cylindrical surfaces and bolts that are circumferentially offset relative to the force-transmitting pins are provided as screwthread elements, screwed into axial bores embodied as threaded bores, which are also embodied in both parts. It is considered particularly advantageous for the bolts to be arranged on the same reference circle as the force-transmitting pins.

In contrast to the connection described in FR 274 958, it is thus possible for hollow cylindrical hubs instead of massive shafts to be connected to disk-shaped parts such as flywheels or flanges not only in a rotationally secured fashion, but also in an axially rigid fashion to form a single rotatable unit or component group in a simple manner. Because the transfer of force and/or rotational momentum falls on the force-transmitting pins alone and the bolts in contrast need only axially secure the connection, they are not burdened by the transfer of rotational momentum, in particular not by shear forces with the danger of breakage of the bolts.

Furthermore according to the invention the coupling a screw formation embodied directly on the parts in that at least one section of the coupling surfaces is embodied at a screw coupling by means of which the outer part may be screwed directly onto the inner part. In particular, this solution has the additional advantage over the first embodiment that no separate screw elements such as bolts or the like are required for axially fixing the parts to be connected to one another in a rotationally secure fashion. Thus, the numerous threaded bores that would otherwise be necessary for this purpose may also be omitted. In this solution, the screwthreads are formed directly on or in the two parts. If the parts are screwed together and the force-transmitting pins are inserted, the screwthread connection is no longer able to loosen.

### BRIEF DESCRIPTION OF THE DRAWING

The above and other objects, features, and advantages will become more readily apparent from the following description, reference being made to the accompanying drawing in which:

FIG. 1 is an axial section through a portion of a coupling according to the invention;

FIG. 2 is a perspective view of the coupling;

FIG. 3 is a large-scale view of a detail of FIG. 1;

FIGS. 4 and 5 are views like FIG. 3 of variants on the coupling of this invention;

FIG. 6 is a perspective view of another embodiment of the coupling according to the invention; and

FIGS. 7, 8, and 9 are views like FIG. 3 of variations on the coupling of FIG. 6.

### SPECIFIC DESCRIPTION

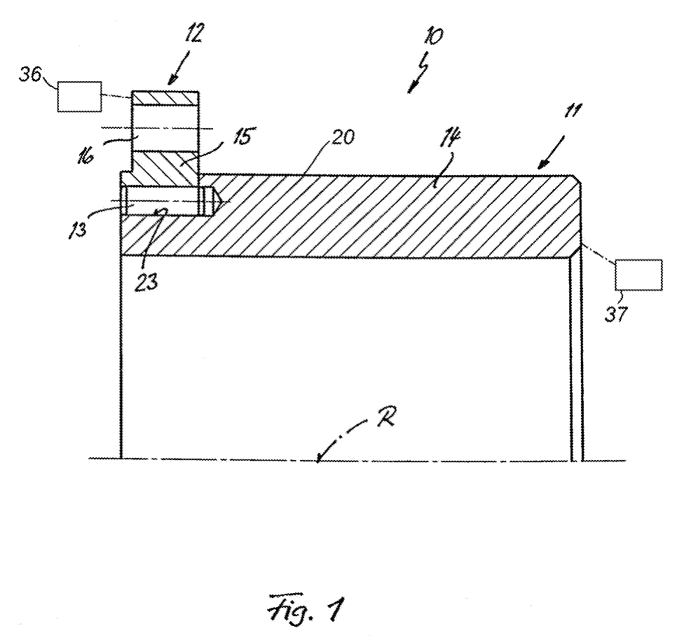

As seen in FIG. 1 a flange hub 10 serves fro transmitting torque about a central rotational axis R between machine components shown schematically at 36 and 37 and between which the flange hub 10 is installed. The flange hub 10 has two parts and includes a first, inner part 11 formed as a body of rotation as well as a second, outer part 12 formed as a body of rotation coaxial with the first part 11. These two parts 11 and 12 are connected to one another in a rotationally secured manner by force-transmitting pins 13 whose arrangement will be discussed in greater detail below.

When the parts 11 and 12 that may rotate around their common rotational axis R serve as a flange hub 10, the inner part 11 is a tubularly hollow cylinder and forms a hub body 14. The second, outer part 12 forms a flange 15 belonging to the hub 14. Bores 16 formed located in the flange 15 outside the hub 14 in a regular circumferential distribution carry screws connected to the component 36.

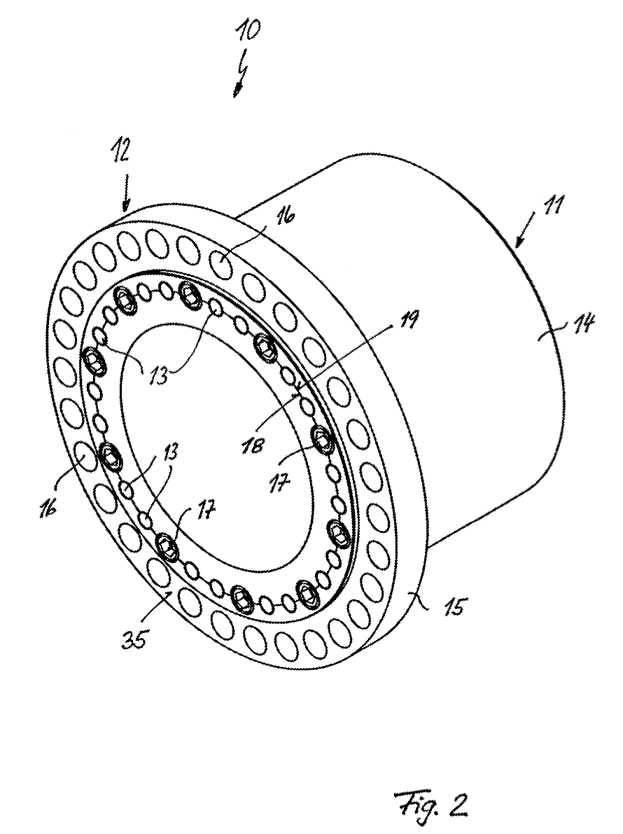

FIG. 2 shows the flange hub 10 in perspective from the flange side and, in addition to the parts and details mentioned above, also shows bolts 17 whose arrangement and significance will also be explained in greater detail below.

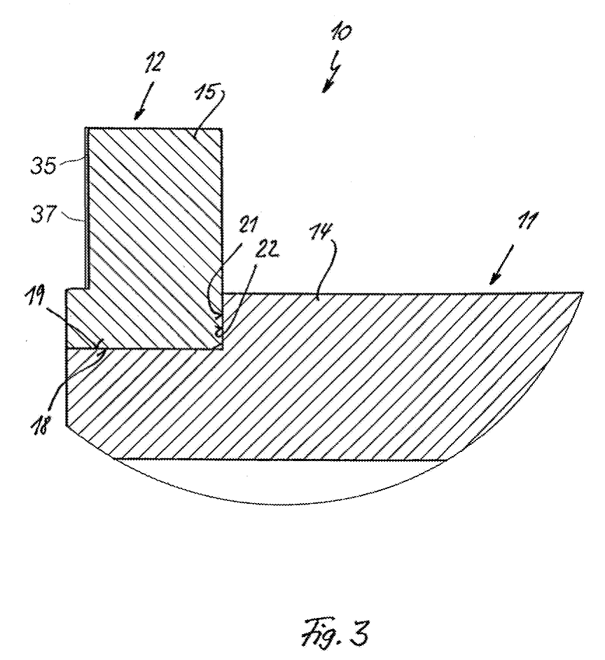

FIG. 3 shows that the outer part 12 forming the flange is an annular disk having a cylindrical inner surface 18 complementary to and fitting flush against an outer cylindrical surface 19 of the inner part 11, i.e. the hub 14 in this case. Thus the surfaces 18 and 19 form faces that connect together the two parts 11 and 12 in a form-fitting fashion. The surfaces 18 and 19 are parallel to and radially inward from a cylindrical outer surface 20 of the hub 14, being formed as an offset with a reduced diameter on the outer end of the hub 14. Another component of the offset portion is a pair of planar coupling faces 21 and 22 lying in a plane perpendicular to the axis R and bearing axially on each other, so as to form an axial stop between the parts 11 and 12. The configuration shown in FIGS. 2 and 3 is used everywhere where the parts 11 and 12 are in direct contact at the radial joint faces 18 and 19 between force-transmitting pins 13 and/or bolts 17.

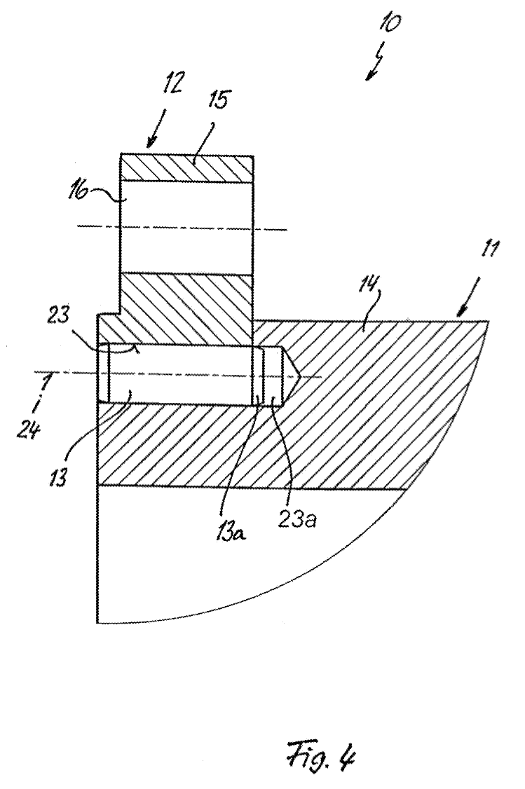

The force-transmitting pins 13 are driven into bores 23 that are half in the inner part 11 or hub 14 and half in the outer part 12 or flange 15 and that are extended along respective axes 24 into the hub 14 at 23a. Thus the outer part 12 is formed with an annular array of radially inwardly open semicylindrical seats forming the outer halves of the bores 23 and the inner part 11 is formed with a complementary annular array of radially outwardly open semicylindrical seats forming the inner halves of the bores 23. The surfaces 18 and 19 meet the bores 23 at diametral planes passing through the respective axes 24. The longitudinal central axes 24 of these bores 23 are parallel to the rotational axis R (FIG. 1) of the arrangement and are identically radially spaced from the axis R as the faces 18 and 19. The force-transmitting pins 13 preferably extend only in the axial region of the second, outer part 12, in this case the flange 15, as also shown in FIG. 4. Only an axially inwardly tapered end portion 13a of the force-transmitting pins 13 extends into the bore extension 23a that is formed only in the hub 14, so that it is not a tight fit therein and cannot transmit torque at this end portion 13a. As shown in FIG. 2, two bores 23 and/or force-transmitting pins 13 alternate angularly with one screw bolt 17. This configuration is not obligatory. Other circumferential distributions are possible and conceivable, although regular ones are preferred.

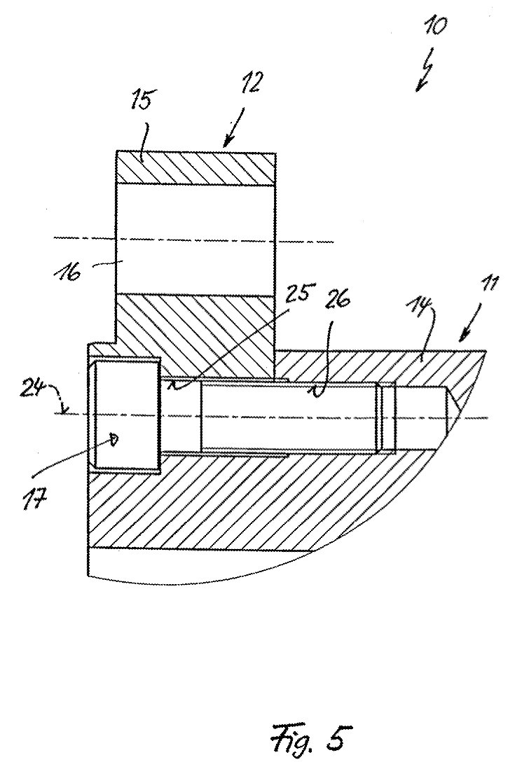

The bolts 17, which are shown in enlarged view in FIG. 5 extend through holes 25 in the outer part 12, i.e. the flange 15 in this case, and engage therein in an inner thread 26 in the inner part 11 or hub 14. The bolts 17 do not serve to transmit force or rotational momentum, but rather only for the axial fixation of the two parts 11 and 12, i.e. for attaching the flange 15 to the face of the hub 14. To this end they fit with radial clearance in the bores 25 that are identical to the bores 23 but of larger diameter.

In the two embodiments described below, these bolts 17 may be omitted.

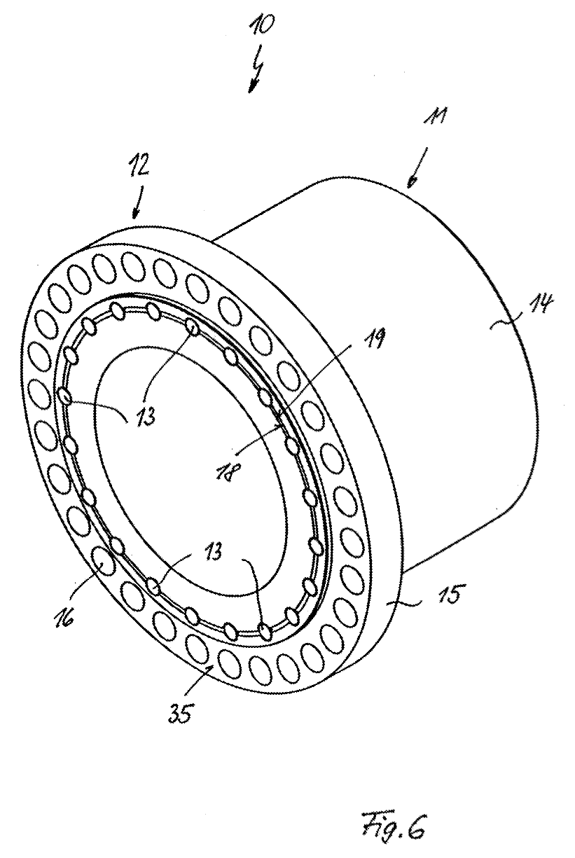

First, the second embodiment shown in FIG. 6 corresponds to FIG. 1 insofar as the inner part 11 formed as a hub 14 and the outer part 12 are connected to one another in a rotationally secured manner via axially aligned force-transmitting pins 13. Instead of the joint formed by the faces 18 and 19 shown in FIG. 3, which is structured there as smooth inner and outer surfaces, the joint surfaces 18 and 19 in FIG. 6 are formed with respective complementary and interfitting screwthreads 27 and 28. Thus the two parts 11 and 12 can be screwed together directly and without the help of any special bolts like the bolts 17. Thus, the flange 15 is screwed onto the hub 14 until both bodies come to rest against one another on the axially oriented stop faces 21 and 22. After this screw attachment, the force-transmitting pins 13 are inserted as described above. Because the force-transmitting pins inhibit rotation between the parts 11 or 14 and 12 or 15, it is therefore no longer possible to release the screw connection at 27 and 28.

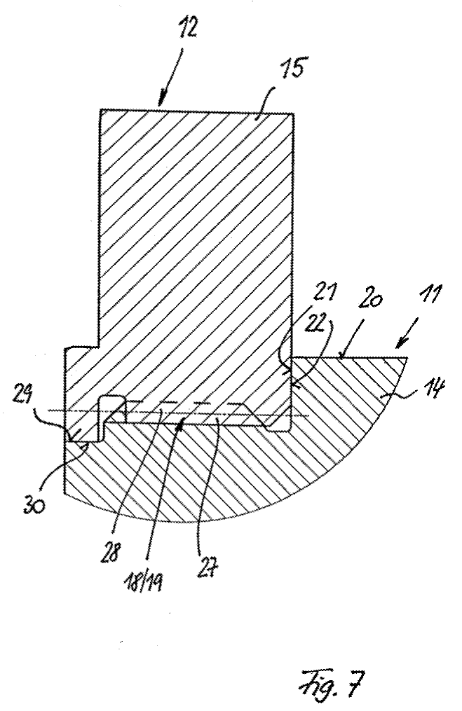

As shown in FIG. 7, the screw threads 27 and 28 are formed on a portion of the hub 14 of smaller diameter than the outer circumference 20 of the hub 14, i.e. corresponding to the faces 18 and 19 of the first embodiment on an offset portion with reduced diameter. In FIG. 7, another radially inwardly offset portion of further reduced diameter is located farther forward. Here, the parts 11 and 12 can slide axially and angularly on each other, being formed with complementary cylindrical surfaces 29 and 30.

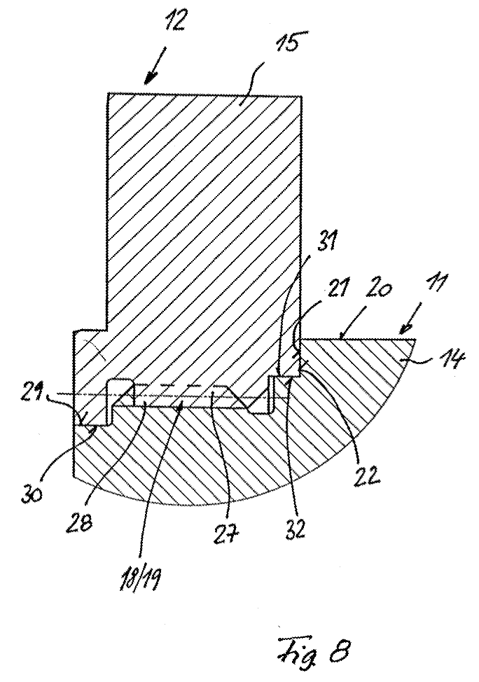

A guide and support means of a somewhat different type is shown in FIG. 8, where, in addition to the guide surfaces 29 and 30 described above, another radial guide with complementary cylindrical guide surfaces 31 and 32 is located rearward of the thread, running up to the faces 21 and 22. In contrast to FIG. 7, the surfaces 31 and 32 are of a diameter greater than that of the pitch circles of the screwthreads 27 and 28 and smaller than that of the outer surface 20. Thus the surfaces 31 and 32 are spaced radially outward from the screwthreads 27 and 28 by about the same amount as the surfaces 29 and 30 are spaced inward therefrom. Here also an axial stop is formed by the annular stop faces 21 and 22.

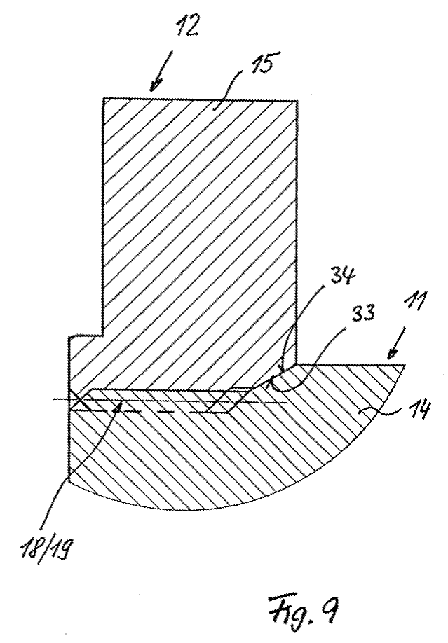

A third guide and stop variant is shown in FIG. 9. Here, the second, outer part 12 (flange 15) forms a radially inwardly directed frustoconical surface 33 facing a complementary radially outwardly directed frustoconical surface 34 of the inner part 11 (hub 14). Due to the frustoconical arrangement of the surfaces 33 and 34, it simultaneously serves as an axial guide as well as a radial support for the two flange sections 11, 12 and 14, 15.

The force-transmitting pins 13, as shown, may be cylindrical pins. As an alternative, it is possible to use tapered pins. In such a case, the bores (simultaneously executed half bores in 11 and 12) must taper complementarily.

Arrangements of the type shown and described above, in particular flange hubs 10, are frequently used in coupling systems, for example, including membrane couplings. The membranes are embodied as thin annular disks whose inner peripheries are clamped against the flange 15. Therefore, it is desirable for an outer face 35 (FIGS. 2, 3, and 6) of the flange 12, to be provided with a coating 37 to increase its static friction, such as aluminum oxide abrasive or diamond dust. This allows a micro-level positive grips between the flange and the membrane. Up to now, this has been impossible or possible only under very difficult conditions with one-piece flange hubs. Because the flange 12 may now be embodied as a simple annular body, it is easily possible to prepare its outer surface 35 before its assembly with the hub 14.

Regarding the structures and/or arrangements of the faces 21 and 22, the surfaces 29 and 30, the surfaces 31 and 32, and the faces 33 and 34 in FIGS. 7-9, they may be combined with one another. Thus, in particular, the embodiment of FIG. 7 may be directly combined with that of FIG. 9. An arrangement of frustoconical surfaces 33, 34 with a double-portion arrangement similar to that in FIG. 8 is also conceivable; the surfaces 31, 32 could have a frustoconical shape, for example. In the case of the embodiment shown in FIG. 8, the front surfaces 29 and 30 may be omitted. In this regard, therefore, the three examples shown should be understood as being particularly advantageous, but not as limiting.

I claim:

1. A rotary coupling comprising:
an inner part centered on and rotatable about a main axis and having a radially outwardly directed outer surface;
an outer part coaxial with the inner part and having a radially inwardly directed inner surface bearing on the inner-part outer surface, the two parts being formed at the surfaces with an annular array of axially extending holes each having an outer half in the outer part and an inner half in the inner part;
respective pins set in the bores and angularly coupling the inner part to the outer part; and
screwthread formations engaged between the inner and outer parts locking same against relative axial movement.

2. The rotary coupling defined in claim 1, further comprising
bolts engaged through the outer part and threaded into bores of the inner part, the screwthread formations being outer screwthreads on the bolts and inner screwthreads in the bores.

3. The rotary coupling defined in claim 2 wherein the bolts are angularly interleaved with the pins, the bolts and pins having respective center axes generally equidistant from the main axis.

4. The rotary coupling defined in claim 1 wherein the screwthread formation includes an inner screwthread on the outer part and a complementary outer screwthread on the inner part.

5. The rotary coupling defined in claim 4 wherein the surfaces are formed axially offset from the screwthreads with respective radially engaging inner and outer smooth surfaces of frustoconical or cylindrical shape centered on the main axis.

6. The rotary coupling defined in claim 5 wherein the parts are formed adjacent the screwthreads with complementary radial offsets forming the respective smooth surfaces.

7. The rotary coupling defined in claim 5 wherein the parts are formed to one axial front side of the screwthreads with a radial offset forming the respective smooth surfaces and of smaller diameter than the screwthreads and to an axially opposite rear side with a radial offset of larger diameter than the screwthreads and forming two more radially engaging smooth surfaces of frustoconical or cylindrical shape centered on the main axis.

8. The rotary coupling defined in claim 1 wherein the inner part is formed as a cylindrical sleeve.

9. The rotary coupling defined in claim 1 wherein the outer part is an annular disk.

10. The rotary coupling defined in claim 1 wherein the inner and outer part form a flange hub.

11. The rotary coupling defined in claim 1 wherein the pins are only in tight radial contact with the inner and outer parts at the surfaces.

12. The rotary coupling defined in claim 11 wherein the pins are cylindrical.

13. The rotary coupling defined in claim 11 wherein the pins and holes are complementarily tapered.

14. The rotary coupling defined in claim 1 wherein an end face of the outer part has a friction-increasing coating.
